(19) United States
(12) Patent Application Publication
(10) Pub. No.: US 2018/0008380 A1
(43) Pub. Date: Jan. 11, 2018

(54) DENTAL IMPLANT INCLUDING CERAMIC FIXTURE

(71) Applicant: Min young LEE, Busan (KR)

(72) Inventor: Min young LEE, Busan (KR)

(21) Appl. No.: 15/639,320

(22) Filed: Jun. 30, 2017

(30) Foreign Application Priority Data
Jul. 6, 2016 (KR) 10-2016-0085357

(51) Int. Cl. A61C 8/00

(52) U.S. Cl. CPC A61C 8/0012; A61C 8/0074; A61C 8/0022; A61C 8/0068

(57) ABSTRACT

The present invention relates to a dental implant, and more particularly, to a dental implant including a fixture 10, an abutment 30 coupled to an upper end of the fixture 10, and an abutment fixing screw 40 coupling the abutment 30 to the fixture 10. The fixture 10 is molded of ceramic and includes a screw part 13 disposed on an outer circumferential surface and a screw hole 14, to which the abutment fixing screw 40 is coupled, disposed in a central axis direction. A helical coil 20 is disposed between the screw hole 14 of the fixture 10 and the abutment fixing screw 40 to couple an outer portion 21a of the helical coil 20 to a screw valley 14a of the screw hole 14 of the ceramic fixture 10 and an inner portion 21b to a valley 41a of the screw part 41 of the abutment fixing screw 40 in a screw coupling manner.

### CROSS-REFERENCE TO RELATED APPLICATIONS

This U.S. non-provisional patent application claims priority under 35 U.S.C. §119 of Korean Patent Application No. 10-2016-0085357, filed on Jul. 6, 2016, the entire contents of which are hereby incorporated by reference.

### BACKGROUND

The present invention relates to a dental implant, and more particularly, to a dental implant including a fixture that is integrally molded of ceramic.

A currently widely used implant for an artificial tooth includes a fixture implanted in an alveolar bone, an abutment coupled to an upper portion of the fixture, and a fixing screw coupling the abutment to the fixture. The fixture that is conventionally made of a titanium alloy is widely used in consideration of mechanical strength, corrosion resistance, and machinability. As a material of the fixture, while the titanium has a light weight, a great rigidity, and an excellent corrosion resistance and biocompatibility, the fixture made of a titanium alloy material contacts gums for a long time to discolor the gums or necrose a portion of the gums, thereby generating periodontitis.

To solve the above-described problem of the titanium fixture, as disclosed in patent document 1 below, trials to manufacture a ceramic fixture have been consistently made. However, although the ceramic material may resolve the above-described disadvantage of the titanium abutment, since the ceramic material has a difficulty in machining due to characteristics of a material having a great brittleness and thus, is necessarily molded by sintering, a screw hole for coupling an abutment fixing screw is difficult to be molded. Even though the screw hole is formed in a ceramic molding process, a fundamental problem generated by the brittleness of the ceramic, e.g., the screw part is damaged by a repeated load after the screw part of the screw hole is coupled to the abutment fixing screw, may not be resolved. Accordingly, as disclosed in the patent document 1 below, it is suggested that the fixture and the abutment are integrally molded so that the fixture and the abutment are not necessarily coupled by the fixing screw.

However, the so-called one-piece type implant produced by integrally molding the fixture and the abutment, which is disclosed in the patent document 1, may resolve the problem of the weak screw hole of the fixture to which the screw is coupled but may not be applied when various kinds of abutments are coupled to the fixture according to a patient's teeth condition.

### PRIOR DOCUMENTS

### Patent Documents

(Patent document 1) KR 10-2010-0022050A

### SUMMARY

To solve a problem of a conventional implant, the present invention provides a dental implant including a ceramic fixture that is integrally molded of ceramic not to be discolored even for a long time usage, increases a coupling strength of a screw hole to which an abutment fixing screw is coupled, and maintains a rigidity enough not to be damaged under a repeated load.

An embodiment of the present invention provides a dental implant in which an abutment is fixed to a fixture by using a fixing screw. Here, the fixture includes a screw part provided on an outer circumferential surface thereof so that the screw part is installed in an alveolar bone and a screw hole, to which the fixing screw is coupled, defined in a central axis direction and is integrally molded of ceramic.

In an embodiment, the dental implant may further include a helical coil disposed between the screw hole of the fixture and the abutment fixing screw and having an outer portion coupled to a screw valley of the screw hole of the ceramic fixture in a screw coupling manner and an inner portion coupled to a screw part of the abutment fixing screw in a screw coupling manner.

In an embodiment, the helical coil may have the outer portion inserted to closely contact a valley of the screw valley of the screw hole of the ceramic fixture and the inner portion inserted to closely contact a valley of the screw part of the abutment fixing screw to couple the abutment fixing screw to the screw hole of the ceramic fixture.

### BRIEF DESCRIPTION OF THE FIGURES

FIG. 1 is an exploded perspective view of a dental implant including a ceramic fixture according to the present invention.

FIG. 2 is a coupled cross-sectional view of the dental implant including the ceramic fixture according to the present invention.

FIG. 3 is an enlarged view illustrating a portion “A” in FIG. 2.

### DETAILED DESCRIPTION

Hereinafter, a preferred embodiment of a dental implant including a ceramic fixture according to the present invention will be described in detail with reference to the accompanying drawings.

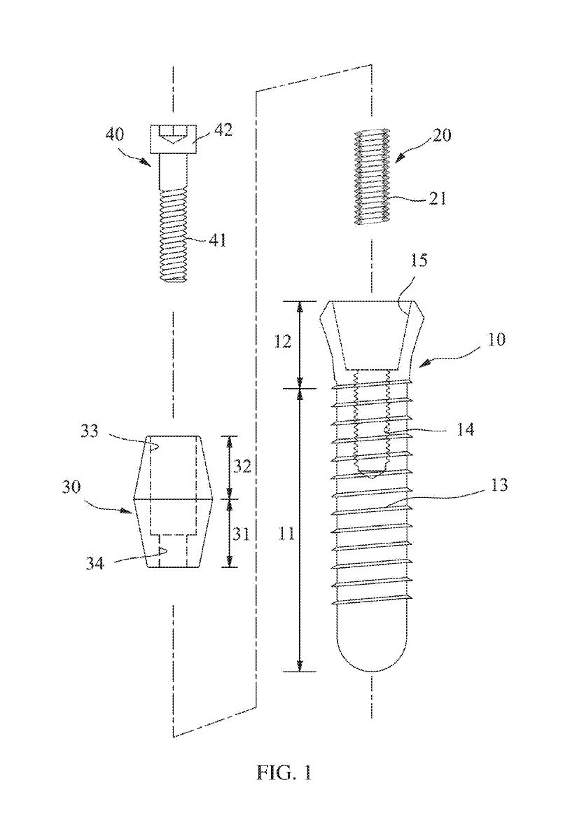

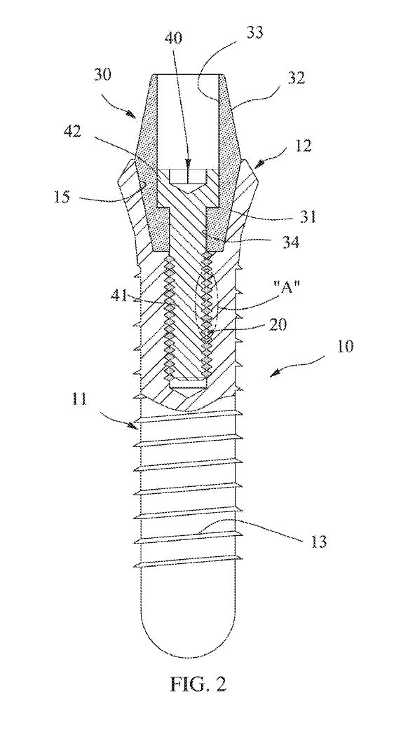

As illustrated in FIGS. 1 and 2, the implant according to the present invention includes a fixture 10 installed in an alveolar bone. The fixture 10 has a structure in which a screw part 13 is formed on an outer circumferential surface of a body 11, an abutment coupling bore 15 is tapered from an upper end of a head part 12 to a predetermined depth along a central axis direction, and a screw hole 14 to which an abutment fixing screw is coupled is defined from a bottom surface of the coupling bore 15 to a predetermined depth along the central axis direction.

Desirably, the fixture 10 is integrally molded of zirconia-based ceramic. That is, the screw part 13 on the outer circumferential surface, the abutment coupling bore 15, and the screw hole 14 are integrated with each other.

Also, the implant according to the present invention includes an abutment 30 that is a component separated from the fixture 10. The abutment 30 is desirably molded of ceramic. The abutment 30 includes a lower portion 31 inserted into the abutment coupling bore 15 of the fixture 10 and an upper portion 32 protruding upward from the head part 12 of the fixture 10, and a fixing screw coupling hole is defined therein to couple the abutment fixing screw 40 thereto. The fixing screw coupling hole includes a lower hole 34 corresponding to an external diameter of a screw part 41 of the fixing screw 40 to allow only the screw part 41 of the fixing screw 40 to pass therethrough and an upper hole 33 having a large diameter into which a head 42 of the fixing screw 40 is inserted. The head 42 of the abutment fixing screw 40 is inserted into the upper hole 33 and is not exposed outside the abutment.

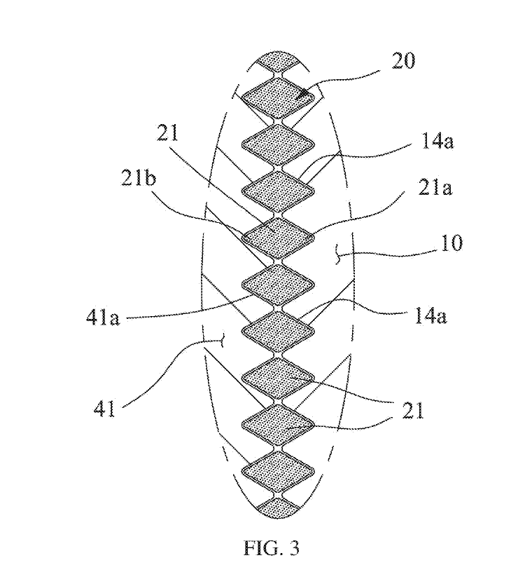

Also, as illustrated in FIGS. 2 and 3, the implant according to the present invention includes a helical coil 20 disposed between the screw hole 14 of the fixture and the screw part 41 of the fixing screw 40 to fix the abutment fixing screw 40 to the fixture 10. The helical coil 20 includes a plurality of coil parts 21 each having a pitch corresponding to a screw pitch of the screw hole 14 of the fixture 10. As illustrated in FIG. 2, each of the coil parts 21 desirably has a cross-sectional shape of which an inner portion 21b and an outer portion 21a are respectively coincided with a screw valley 14a of the screw hole 14 of the fixture 10 and a valley 41a of the screw part 41 of the abutment fixing screw 40.

FIG. 2 illustrates a coupled cross-sectional view of the implant according to the present invention. As illustrated in FIG. 2, the implant according to the present invention is assembled by inserting the helical coil 20 into the screw hole 14 of the fixture 10 installed in the alveolar bone in a screw coupling manner. Here, the outer portion 21a of each of the coil parts 21 of the helical coil 20 is inserted to closely contact the screw valley 14a of the screw hole 14 of the fixture 10. Thereafter, the abutment 30 is disposed on the upper end of the fixture so that the lower portion 31 of the abutment 30 is seated in an upper end in the abutment coupling bore 15 of the fixture 10. As the screw part 41 passes through the fixing screw coupling hole of the abutment, and accordingly, the abutment fixing screw 40 is coupled to the inner portion 21b of the helical coil 20 coupled to the screw hole 14 of the fixture 10 in a screw coupling manner, the abutment 30 is fixed in a state in which the abutment 30 is coupled to the upper end of the fixture 10.

As illustrated in FIG. 3, in the helical coil 20, the outer portion 21a of each of the coil parts 21 is coincided with the screw valley 14a of the screw hole 14 of the ceramic fixture, and the inner portion 21b thereof is coincided with the valley 41a of the screw part 41 of the abutment fixing screw 40. As described above, since the fixture 10 is molded of ceramic, the screw part of the screw hole 14 is weak. However, since the abutment fixing screw 40 is coupled to the screw hole 14 by a medium of the helical coil 20, the helical coil 20 buffers by absorbing an external force or a repeated load that is transmitted through the abutment fixing screw 40 Accordingly, the abutment fixing screw 40 and the screw hole 14 of the fixture 10 are firmly coupled to each other.

For this, the helical coil may be made of a synthetic resin material that is harmless to humans.

According to the above-described implant of the present invention, since the fixture is molded of ceramic, the fixture is not varied in color even after long-time usage. The helical coil is disposed between the screw hole of the fixture and the abutment fixing screw to increase the coupling strength of the screw hole. Thus, the implant may maintain the rigidity enough not to be damaged even under the repeated load.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

### DESCRIPTION OF SYMBOLS

10: fixture 11: body
12: head portion 13: screw part
14: screw hole 14a: screw valley
15: coupling bore
20: helical coil 21: coil part
21a: outer portion 21b: inner portion
30: abutment 31: lower portion
32: upper portion 33: upper hole
34: lower hole 40: abutment fixing screw
41: screw part 41a: valley
42: head

What is claimed is:

1. A dental implant comprising a ceramic fixture, which comprises a fixture (10), an abutment (30) coupled to an upper end of the fixture (10), and an abutment fixing screw (40) coupling the abutment (30) to the fixture (10),
wherein the fixture (10) comprises a screw part (13) provided on an outer circumferential surface thereof and a screw hole (14), to which the abutment fixing screw (40) is coupled, defined therein and is molded of ceramic.

2. The dental implant f claim 1, further comprising a helical coil (20) disposed between the screw hole (14) of the fixture (10) and the abutment fixing screw (40) to couple the screw hole (14) of the ceramic fixture (10) to a screw part (41) of the abutment fixing screw (40) in a screw coupling manner.

3. The dental implant of claim 2, wherein the helical coil (20) has an outer portion (21a) inserted to closely contact a valley of a screw valley (14a) of the screw hole (14) of the ceramic fixture (10) and an inner portion (21b) inserted to closely contact a valley of a screw part of the abutment fixing screw (40) to couple the abutment fixing screw (40) to the screw hole (14) of the ceramic fixture (10).
